(19) United States
(12) Patent Application Publication
(10) Pub. No.: US 2025/0018515 A1
(43) Pub. Date: Jan. 16, 2025

(54) TABLE SAW DUST DEFLECTION SYSTEM

(71) Applicant: JPW INDUSTRIES INC., LaVergne, TN (US)

(72) Inventors: Timothy Gale Birdwell, Lafayette, TN (US); Jeffery Lee Konkle, Murfreesboro, TN (US); Charles Weber, Onalaska, WI (US); Thomas Balko, La Crosse, WI (US)

(21) Appl. No.: 18/768,687

(22) Filed: Jul. 10, 2024

Related U.S. Application Data
(60) Provisional application No. 63/525,812, filed on Jul. 10, 2023.

(51) Int. Cl. B23D 59/00; B23D 45/06

(52) U.S. Cl. CPC B23Q 11/005

(57) ABSTRACT

A table saw dust deflection system as disclosed herein may include a table saw, and a saw dust chute having a main receptacle and a dust exhaust channel. The saw dust chute may improve the collection of sawdust from a table saw. The table saw may include a worksurface and a saw blade extending partially through the worksurface and including an axis. The main receptacle may be shaped to receive a portion of the saw blade and may include a forward upper edge. The dust exhaust channel may include an exhaust channel opening with a forward exhaust channel edge positioned less than 90 degrees from a forwardmost cutting point of the saw blade relative to the axis of the saw blade. The forwardmost cutting point may be defined at a forward intersection point between the saw blade and the worksurface.

### CROSS-REFERENCES TO RELATED APPLICATIONS

This is a non-provisional patent application claiming priority to co-pending U.S. Provisional Patent Application Ser. No. 63/525,812 filed Jul. 10, 2023, and entitled “Table Saw Dust Deflection System”.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

### 1. Field of the Invention

The present disclosure relates generally to power table saws. More particularly, the present disclosure pertains to table saw dust deflection and collection systems.

### 2. Description of the Prior Art

Table saws generally eject debris (or dust) from its saw blade into a collection bin of the table saw while cutting a workpiece. The majority of the saw blade, as well as the motor and other functional parts of the saw are generally also positioned within the collection bin. The collection bin positioned below the saw blade may not effectively capture all the dust, leading to dust escaping into the surrounding area or collecting on the various functional parts of the table saw positioned within the collection bin, thereby compromising the functional integrity and reliability of the table. The dust can also be force toward the user or the user's face in front of the table saw which can make for an unpleasant and dangerous working experience, particular if the saw dust and chips are directed toward the user's eyes. Even with a dust collection system, such as a vacuum, applying negative pressure to the collection bin, the dust still ejects from the saw randomly and may still end up negatively impacting the functional parts of the table saw and the user experience.

### BRIEF SUMMARY

In view of at least some of the above-referenced problems in conventional table saw debris collection, an exemplary object of the present disclosure may be to provide a new dust deflection system and saw dust chute for a table saw. The saw dust chute may be configured to optimally catch and direct sawdust ejected from the saw blade. The saw dust chute improves the collection of sawdust from a table saw via gravitational collection but may further optimize collection when used in connection with a dust collection system including a vacuum configured to apply negative pressure to the saw dust chute.

In a particular embodiment, an exemplary table saw dust deflection system as disclosed herein may include a table saw and a saw dust chute coupled to the table saw. The table saw may have a worksurface and a saw blade extending partially through the worksurface. The saw blade may include an axis about which it rotates. The saw dust chute may include a main receptacle and a dust exhaust channel. The main receptacle may be shaped to receive a portion of the saw blade. The main receptacle may have a forward upper edge. The dust exhaust channel may have an exhaust channel opening with a forward exhaust channel edge positioned less than ninety (90) degrees from a forwardmost cutting point of the saw blade relative to the axis of the saw blade. The forwardmost cutting point may be defined at a forward intersection point between the saw blade and the worksurface.

In an exemplary aspect according to the above-referenced embodiment, the forward upper edge of the main receptacle may be positioned adjacent to a lower surface of the worksurface.

In another exemplary aspect according to the above-referenced embodiment, the dust exhaust channel may further include a primary upper channel and a secondary lower channel, and the exhaust channel opening may further include a primary upper channel opening open to the primary upper channel and a secondary lower channel opening open to the secondary lower channel. The primary upper channel opening may be positioned between the secondary lower channel opening and the forward upper edge. The secondary lower channel opening may be positioned below the primary upper channel opening. Each of the primary upper channel opening and the secondary lower channel opening may be oriented to feed dust into the dust exhaust channel during operation of the table saw.

In another exemplary aspect according to the above-referenced embodiment, a tangent of the saw blade defined at the forwardmost cutting point may intersect the primary upper channel opening.

In another exemplary aspect according to the above-referenced embodiment, the exhaust channel opening may be positioned directly below the forwardmost cutting point in a direction perpendicular to the worksurface.

In another exemplary aspect according to the above-referenced embodiment, the forward exhaust channel edge of the exhaust channel opening may be positioned forward of the forwardmost cutting point relative to the worksurface.

In another exemplary aspect according to the above-referenced embodiment, the saw dust chute may include a first side surface positioned adjacent to a first side of the saw blade. The first side surface may include a first side surface upper edge. The saw dust chute may further include a second side surface positioned adjacent to a second side of the saw blade opposite the first side. The second side surface may include a second side surface upper edge positioned lower than the first side surface upper edge relative to the worksurface.

In another exemplary aspect according to the above-referenced embodiment, the second side surface upper edge may move towards a lower surface of the worksurface when the saw blade moves to a maximally angled position relative to the worksurface.

In another exemplary aspect according to the above-referenced embodiment, the system may further include a dust cover assembly configured to cover a gap between the second side surface upper edge and a lower surface of the worksurface.

In another exemplary aspect according to the above-referenced embodiment, the dust cover assembly may be configured to maintain coverage of the gap when an angle of the saw blade is changed relative to the worksurface.

In another exemplary aspect according to the above-referenced embodiment, the dust cover assembly may be biased to maintain contact with one or more of the second side surface upper edge or the lower surface of the worksurface

In another exemplary aspect according to the above-referenced embodiment, the exhaust channel opening of the dust exhaust channel may be positioned further below the worksurface than a lowest point of the saw blade.

In another exemplary aspect according to the above-referenced embodiment, a rearward exhaust channel edge of the channel opening is positioned less than one-hundred-twenty (120) degrees from the forwardmost cutting point of the saw blade relative to the axis of the saw blade.

In a particular embodiment, an exemplary table saw dust deflection system as disclosed herein may include a table saw and a saw dust chute coupled to the table saw. The table saw may have a worksurface and a saw blade extending partially through the worksurface. The saw blade may include an axis about which it rotates. The saw dust chute may include a main receptacle and a dust exhaust channel. The main receptacle may be shaped to receive a portion of the saw blade. The main receptacle may have a forward upper edge. The dust exhaust channel may have an exhaust channel opening with a rearward exhaust channel edge positioned less than one-hundred-twenty (120) degrees from a forwardmost cutting point of the saw blade relative to the axis of the saw blade. The forwardmost cutting point may be defined at a forward intersection point between the saw blade and the worksurface.

In an exemplary aspect according to the above-referenced embodiment, the dust exhaust channel may further include a primary upper channel and a secondary lower channel, and the exhaust channel opening may further include a primary upper channel opening open to the primary upper channel and a secondary lower channel opening open to the secondary lower channel. The primary upper channel opening may be positioned between the secondary lower channel opening and the forward upper. The secondary lower channel opening may be positioned between the primary upper channel opening and the rearward exhaust channel edge. Each of the primary upper channel opening and the secondary lower channel opening may be oriented to feed dust into the dust exhaust channel during operation of the table saw.

In another exemplary aspect according to the above-referenced embodiment, a tangent of the saw blade defined at the forwardmost cutting point intersects the primary upper channel opening.

In another exemplary aspect according to the above-referenced embodiment, the main receptacle of the saw dust chute includes a first side surface and a second side surface. The first side surface may be positioned adjacent to a first side of the saw blade, the first side surface including a first side surface upper edge. The second side surface of the saw dust chute may be positioned adjacent to a second side of the saw blade opposite the first side. The second side surface may include a second side surface upper edge positioned lower than the first side surface upper edge.

In another exemplary aspect according to the above-referenced embodiment, the second side surface upper edge may moves towards a lower surface of the worksurface when the saw blade moves to a maximally angled position relative to the worksurface.

In another exemplary aspect according to the above-referenced embodiment, the system may further include a dust cover assembly configured to cover a gap between the second side surface upper edge and a lower surface of the worksurface.

In another exemplary aspect according to the above-referenced embodiment, the dust cover assembly may be configured to maintain coverage of the gap when an angle of the saw blade is changed relative to the worksurface.

### BRIEF DESCRIPTION OF THE SEVERAL VIEWS OF THE DRAWINGS

FIG. 1 illustrates a cross-sectional perspective view of an embodiment of a table saw dust deflection system in accordance with the present disclosure.

FIG. 2 illustrates a cross-sectional perspective view of another embodiment of a table saw dust deflection system in accordance with the present disclosure.

FIG. 3 illustrates a cross-sectional front side view of the table saw dust deflection system of FIG. 1 in accordance with the present disclosure.

FIG. 4 illustrates a cross-sectional front side view of the table saw dust deflection system of FIG. 2 in accordance with the present disclosure.

FIG. 5 illustrates a cross-sectional left side view of the table saw dust deflection system of FIG. 1 in accordance with the present disclosure.

FIG. 6 illustrates a cross-sectional left side view of the table saw dust deflection system of FIG. 2 in accordance with the present disclosure.

FIG. 7 illustrates an exploded perspective view of a saw dust chute of the table saw dust deflection system of FIG. 1 in accordance with the present disclosure.

FIG. 8 illustrates a perspective view of a saw dust chute of the table saw dust deflection system of FIG. 2 in accordance with the present disclosure.

FIG. 9 illustrates an enlarged perspective view of the table saw dust deflection system of FIG. 1 with an embodiment of a dust cover assembly overlapping the saw dust chute in accordance with the present disclosure.

FIG. 10 illustrates an enlarged perspective view of the table saw dust deflection system of FIG. 2 with an embodiment of a dust cover assembly overlapping the saw dust chute in accordance with the present disclosure.

FIG. 11 illustrates an enlarged perspective view of the table saw dust deflection system of FIG. 1 with another embodiment of a dust cover assembly overlapping the saw dust chute in accordance with the present disclosure.

FIG. 12 illustrates an enlarged perspective view of the table saw dust deflection system of FIG. 2 with another embodiment of a dust cover assembly overlapping the saw dust chute in accordance with the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

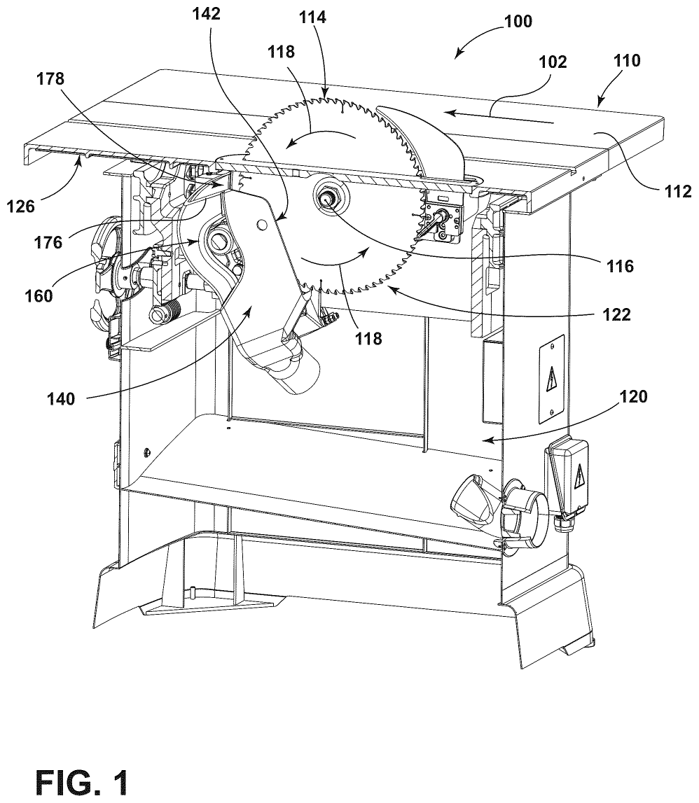

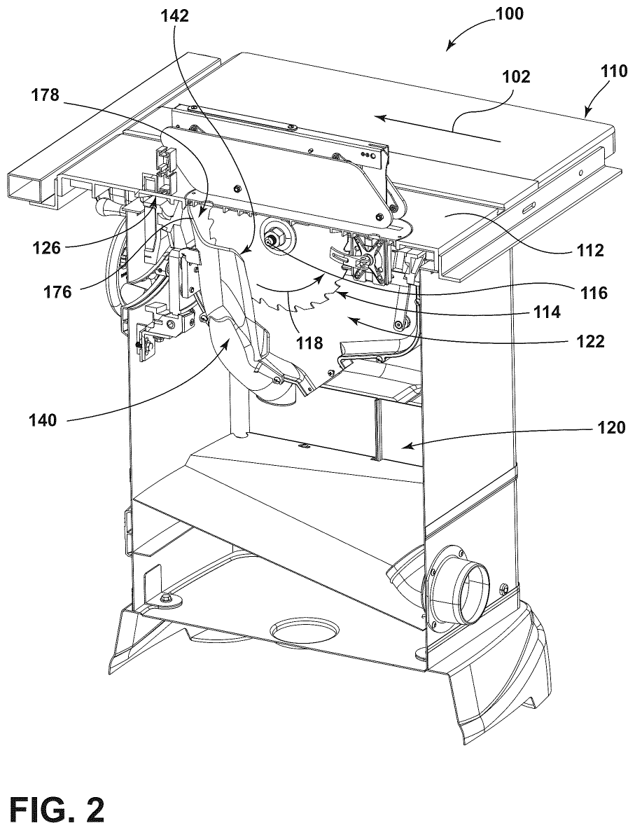

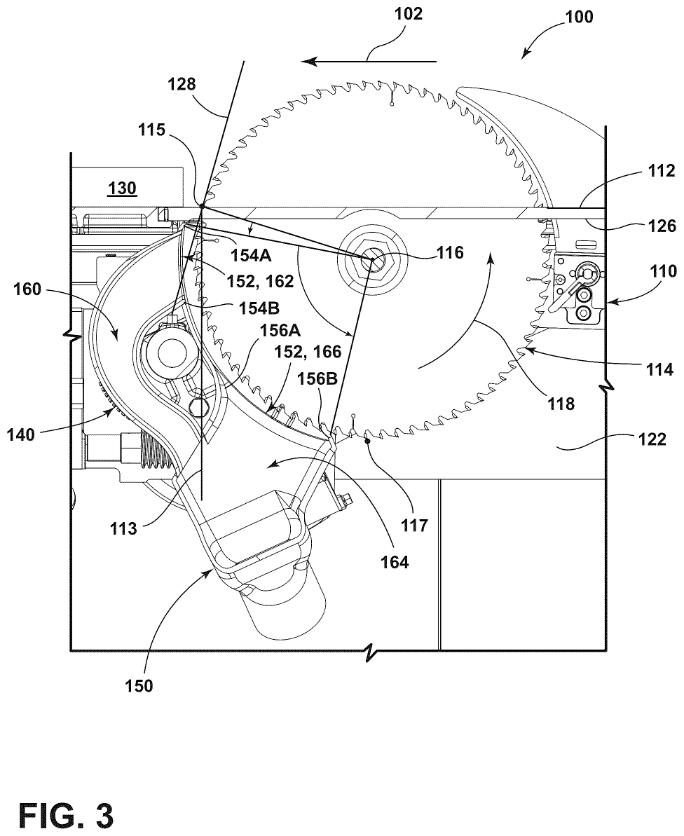

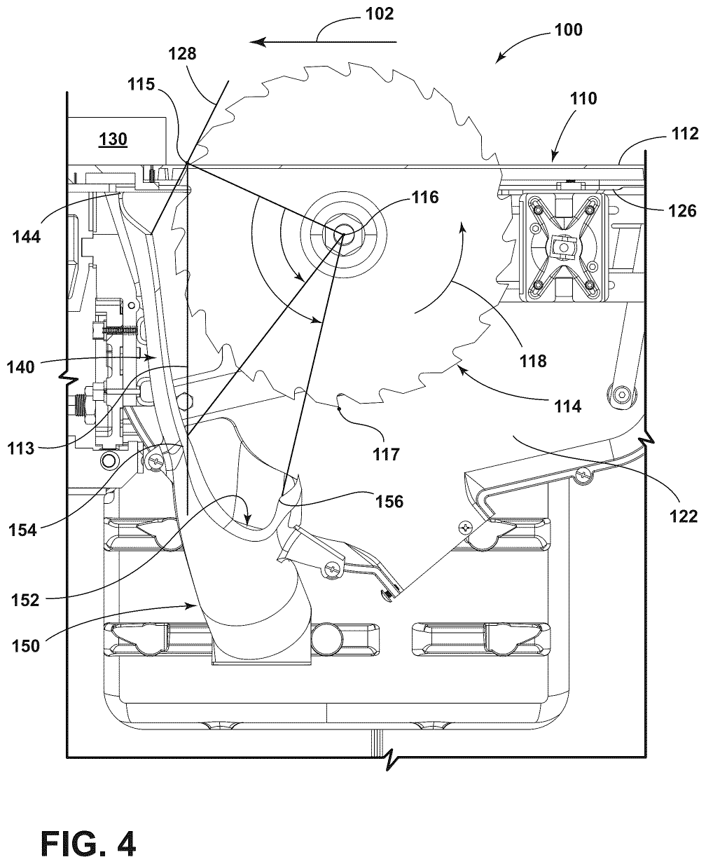

Referring to FIGS. 1-6 and 9-10, various embodiments of a table saw dust deflection system 100 are illustrated. The table saw dust deflection system 100 may include a table saw 110 having a worksurface 112 and a saw blade 114 extending partially through the worksurface 112. The saw blade 114 may include an axis 116 about which it is configured to spin. A direction of rotation 118 of the saw blade 114 is illustrated by arrow 118. The saw blade 114 may be configured to cut a workpiece 130 (illustrated in FIGS. 3-4). A forwardmost cutting point 115 of the saw blade 114 may be the first interaction between the saw blade 114 and the workpiece 130 when cutting the workpiece 130. The forwardmost cutting point 115 may also be referred to herein as a forward intersection point 115 between the saw blade 114 and the worksurface 112. Sawdust from the workpiece 130 may be expelled from the saw blade 114 as it rotates through an opening in the worksurface 112. The expelled sawdust is generally contained by a collection bin 120 of the table saw 110, however, the sawdust may move within the collection bin 120 and stick to various functional parts of the table saw, such as, for example, the carriage assembly 122 to which the saw blade 114 and drive motor 124 (shown in FIG. 6) are attached. In some prior art devices dust can be trapped within the saw blades and expelled from the back side of the blade is it emerges from below the work surface and direct saw dust towards the user or generally outside of the table saw 110.

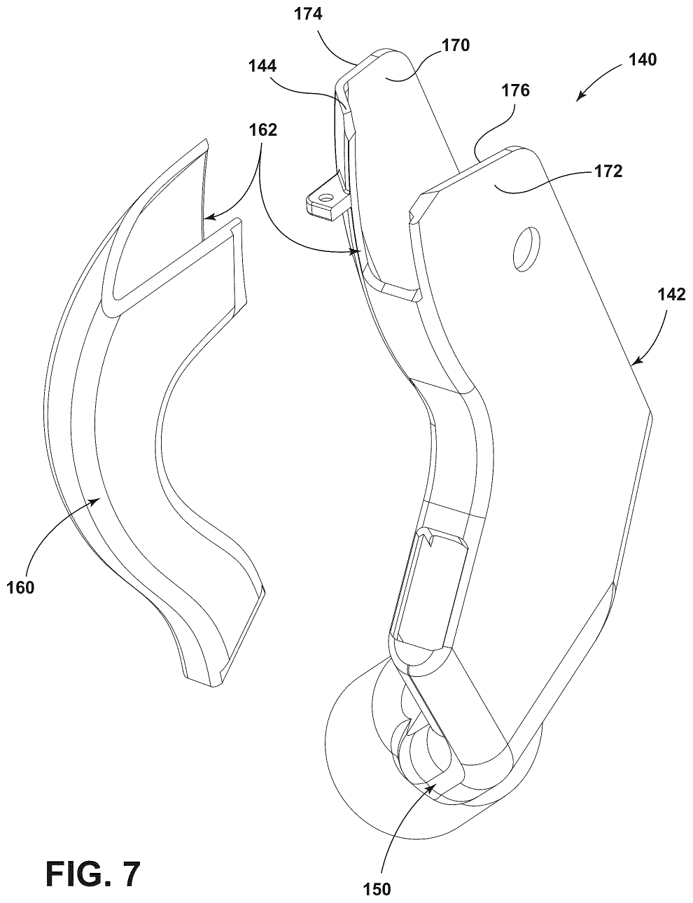

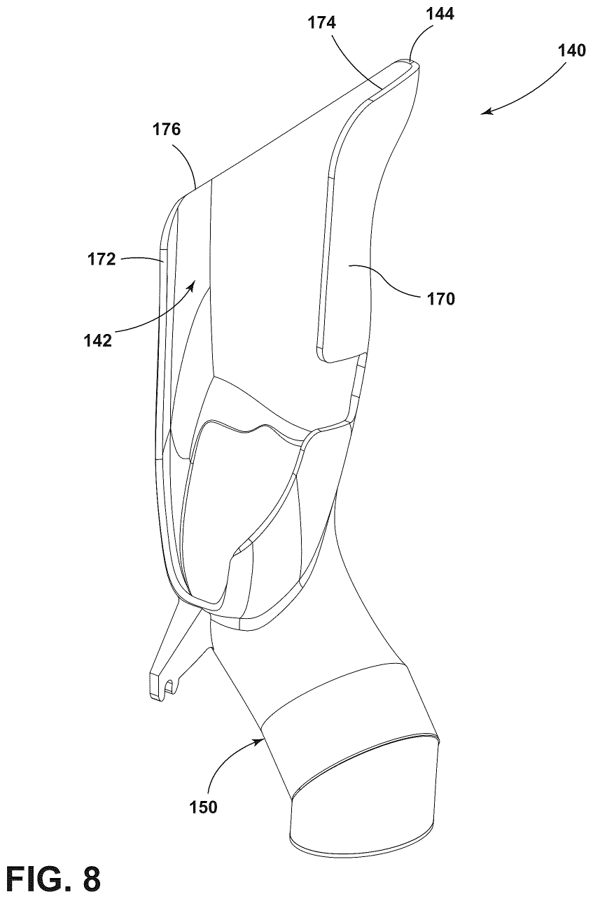

The table saw dust deflection system 100 may further include a saw dust chute 140 configured to receive and redirect the sawdust ejected from the saw blade 114. The saw dust chute 140 may be configured to at least partially surround a portion of the saw blade 114 positioned beneath the worksurface 112. The saw dust chute 140 may be coupled to the carriage assembly 122 of the table saw 110 using tabs of the saw dust chute 140 that align with existing fasteners of the carriage assembly 122. Isolated views of several embodiments of the saw dust chute 140 are illustrated in FIGS. 7-8. While illustrated as multiple pieces in FIG. 7, the saw dust chute 140 may preferably be integrally formed, however, in certain optional embodiments, it may comprise multiple pieces connected together.

Referring again to FIGS. 1-6, the saw dust chute 140 may include a main receptacle 142 shaped to receive a portion of the saw blade 114 and a dust exhaust channel 150 configured to receive and redirect the sawdust expelled by the blade 114. In certain optional embodiments, the dust exhaust channel 150 may extend or be laterally offset from the saw blade 114 based at least in part on structural restrictions surrounding the carriage assembly 122. The main receptacle 142 may include a forward upper edge 144. The forward upper edge 144 may at least partially contact a lower surface 126 of the worksurface 112. In other optional embodiments, the forward upper edge 144 may be positioned extremely close or adjacent to the lower surface 126 of the worksurface 112, for example, within about 5 mm. The dust exhaust channel 150 may extend in a downward direction or at least partially downward direction relative to the worksurface 112. This configuration may take advantage of gravity when redirecting the sawdust collected by the main receptacle 142 into the dust exhaust channel 150.

As illustrated in FIGS. 3-4, the dust exhaust channel 150 may include an exhaust channel opening 152 having a forward exhaust channel edge 154 and a rearward exhaust channel edge 156 positioned rearward of the forward exhaust channel edge 154 relative to a forward direction 102. For example, the forward exhaust channel edge 154 may be offset from the rearward exhaust channel edge 156 parallel to the worksurface 112. In some embodiments, the exhaust channel opening 152 of the dust exhaust channel 150 may be positioned further below the worksurface 112 than a lowest point 117 of the saw blade 114. In other embodiments, the exhaust channel opening may be shaped to contour or mirror a portion of the blade 114.

The forward exhaust channel edge 154 may be positioned less than ninety (90) degrees from a forwardmost cutting point 115 of the saw blade 114 relative to the axis 116 of the saw blade 114 in the direction of rotation 118 of the saw blade 114. In certain optional embodiments, the forward exhaust channel edge 154 may be positioned less than ninety-five (95) degrees from the forwardmost cutting point 115 of the saw blade 114 relative to the axis 116. In other optional embodiments, the forward exhaust channel edge 154 may be positioned less than one-hundred (100) degrees from the forwardmost cutting point 115 of the saw blade 114 relative to the axis 116. In further optional embodiments, the forward exhaust channel edge 154 may be positioned less than one-hundred-five (105) degrees from the forwardmost cutting point 115 of the saw blade 114 relative to the axis 116. In still further optional embodiments, the forward exhaust channel edge 154 may be positioned less than one-hundred-ten (110) degrees from the forwardmost cutting point 115 of the saw blade 114 relative to the axis 116. In other optional embodiments, the forward exhaust channel edge 154 may be positioned less than one-hundred-fifteen (115) degrees from the forwardmost cutting point 115 of the saw blade 114 relative to the axis 116. In further optional embodiments, the forward exhaust channel edge 154 may be positioned less than one-hundred-twenty (120) degrees from the forwardmost cutting point 115 of the saw blade 114 relative to the axis 116. In still further optional embodiments, the forward exhaust channel edge 154 may be positioned less than one-hundred-eighty (180) degrees from the forwardmost cutting point 115 of the saw blade 114 relative to the axis 116. In certain optional embodiments, the forward exhaust channel edge 154 may be positioned less than eighty-five (85) degrees from the forwardmost cutting point 115 of the saw blade 114 relative to the axis 116. In other optional embodiments, the forward exhaust channel edge 154 may be positioned less than eighty (80) degrees from the forwardmost cutting point 115 of the saw blade 114 relative to the axis 116. In certain optional embodiments, the forward exhaust channel edge 154 may be positioned less than seventy-five (75) degrees from the forwardmost cutting point 115 of the saw blade 114 relative to the axis 116. In further optional embodiments, the forward exhaust channel edge 154 may be positioned less than seventy (70) degrees from the forwardmost cutting point 115 of the saw blade 114 relative to the axis 116. In still further optional embodiments, the forward exhaust channel edge 154 may be positioned less than sixty-five (65) degrees from the forwardmost cutting point 115 of the saw blade 114 relative to the axis 116. In still further optional embodiments, the forward exhaust channel edge 154 may be positioned less than forty-five (45) degrees from the forwardmost cutting point 115 of the saw blade 114 relative to the axis 116.

The rearward exhaust channel edge 156 may be positioned less than one-hundred (100) degrees from the forwardmost cutting point 115 of the saw blade 114 relative to the axis 116 of the saw blade 114 in the direction of rotation 118 of the saw blade 114. In certain optional embodiments, the rearward exhaust channel edge 156 may be positioned less than ninety-five (95) degrees from the forwardmost cutting point 115 of the saw blade 114 relative to the axis 116. In other optional embodiments, the rearward exhaust channel edge 156 may be positioned less than ninety (90) degrees from the forwardmost cutting point 115 of the saw blade 114 relative to the axis 116. In further optional embodiments, the rearward exhaust channel edge 156 may be positioned less than eighty-five (85) degrees from the forwardmost cutting point 115 of the saw blade 114 relative to the axis 116. In still further optional embodiments, the rearward exhaust channel edge 156 may be positioned less than eighty (80) degrees from the forwardmost cutting point 115 of the saw blade 114 relative to the axis 116. In certain optional embodiments, the rearward exhaust channel edge 156 may be positioned less than seventy-five (75) degrees from the forwardmost cutting point 115 of the saw blade 114 relative to the axis 116. In other optional embodiments, the rearward exhaust channel edge 156 may be positioned less than seventy (70) degrees from the forwardmost cutting point 115 of the saw blade 114 relative to the axis 116. In certain optional embodiments, the rearward exhaust channel edge 156 may be positioned less than one-hundred-five (105) degrees from the forwardmost cutting point 115 of the saw blade 114 relative to the axis 116. In other optional embodiments, the rearward exhaust channel edge 156 may be positioned less than one-hundred-ten (110) degrees from the forwardmost cutting point 115 of the saw blade 114 relative to the axis 116. In further optional embodiments, the rearward exhaust channel edge 156 may be positioned less than one-hundred-fifteen (115) degrees from the forwardmost cutting point 115 of the saw blade 114 relative to the axis 116. In still further optional embodiments, the rearward exhaust channel edge 156 may be positioned less than one-hundred-twenty (120) degrees from the forwardmost cutting point 115 of the saw blade 114 relative to the axis 116. In certain other optional embodiments, the rearward exhaust channel edge 156 may be positioned less than one-hundred-twenty-five (125) degrees from the forwardmost cutting point 115 of the saw blade 114 relative to the axis 116. In other optional embodiments, the rearward exhaust channel edge 156 may be positioned less than 130, 135, 140, 145, 150, 155, 160, 165, 170, 175, 180, 185, or 190 degrees from the forwardmost cutting point 115 of the saw blade 114 relative to the axis 116.

Various angular combinations between the forward exhaust channel edge 154 and the rearward exhaust channel edge 156 may be possible. An angular range between the forward exhaust channel edge 154 and the rearward exhaust channel edge 156 relative to the axis 116 may be no more than fifteen (15) degrees. In certain optional embodiments, the angular range between the forward exhaust channel edge 154 and the rearward exhaust channel edge 156 relative to the axis 116 may be no more than twenty (20) degrees. In other optional embodiments, the angular range between the forward exhaust channel edge 154 and the rearward exhaust channel edge 156 relative to the axis 116 may be no more than twenty-five (25) degrees. In further optional embodiments, the angular range between the forward exhaust channel edge 154 and the rearward exhaust channel edge 156 relative to the axis 116 may be no more than thirty (30) degrees. In still further optional embodiments, the angular range between the forward exhaust channel edge 154 and the rearward exhaust channel edge 156 relative to the axis 116 may be no more than thirty-five (35) degrees. In certain other optional embodiments, the angular range between the forward exhaust channel edge 154 and the rearward exhaust channel edge 156 relative to the axis 116 may be no more than 40, 45, 50, 55, 60, 65, 70, 75, 80, 85, or 90 degrees.

In some embodiments, the exhaust channel opening 152 can be positioned along a tangent 128 line of the blade relative to the forwardmost cutting point 115 of the saw blade 114. As such, as the blade cuts a workpiece 130, the saw dust produced can be free to travel tangentially from the blade 114 in a tangential direction and into the dust exhaust channel 150. Such an arrangement can help prevent saw dust from getting pulled by the blade once cut up and out of the table saw 110. In other embodiments, it may be difficult to position the exhaust channel opening 152 and thus the dust exhaust channel 150 along such a tangent 128, but the exhaust channel opening 152 and thus the dust exhaust channel 150 can be positioned radially farther down the saw blade 114 but generally adjacent a forward lower quarter of the saw blade 114 as disclosed herein to help encourage saw dust from the saw blade to enter into the dust exhaust channel 150.

In certain optional embodiments, as illustrated in FIGS. 1, 3, and 7, the dust exhaust channel 150 can further include a primary upper channel 160 and a secondary lower channel 164, and the exhaust channel opening 152 further includes a primary upper channel opening 162 open to the primary upper channel 160 and a secondary lower channel opening 166 opening to the secondary lower channel 164. The primary upper channel opening may be positioned between the secondary lower channel opening 166 and the forward upper edge 144. The secondary lower channel opening 166 may be positioned below the primary upper channel opening 162, and/or between the primary upper channel opening 162 and the rearward exhaust channel edge 156. Each of the primary upper channel opening 162 and the secondary lower channel opening 166 may be oriented to feed dust into the dust exhaust channel 150 during operation of the table saw 110 via the primary upper channel 160 and the secondary lower channel 164 respectively. The primary upper channel opening 162 may also be referred to herein as a primary channel opening 162. The secondary lower channel opening 166 may also be referred to herein as a secondary channel opening 166.

The primary upper channel 160 can allow the primary upper channel opening 162 to be positioned higher up on the dust exhaust channel 150, and thus closer to the forwardmost contact point 115 between the blade 114 and the workpiece 130, while allowing the primary upper channel 160 to extend around and thus avoid various obstacles (e.g., fasteners, etc.) of the table saw 110 proximate the saw blade 114. The primary upper channel opening 162 may extend proximate from the forward upper edge 144 of the saw dust chute 140. In certain optional embodiments, a tangent 128 of the saw blade 114 defined at the forwardmost cutting point 115 may intersect the primary upper channel opening 162.

The secondary lower channel opening 166 may be positioned lower than the primary upper channel opening 162 such that the secondary lower channel opening 166 can receive any saw dust not received by the primary upper channel opening 162. In some embodiments including a secondary lower channel 164, the primary upper channel 160 and the secondary lower channel 164 can merge to allow all saw dust collected in either channel 160 or 164 to flow out of a single outlet of the dust exhaust channel 150 and int the collection chamber 120. In other embodiments, both the primary upper channel opening 162 and the secondary lower channel opening 166 can extend into the primary upper channel 160 but at two different locations, thus eliminating the need for a secondary lower channel 164.

The exhaust channel opening 152 may be positioned directly below the forwardmost cutting point 115 in a direction perpendicular to the worksurface 112. In certain optional embodiments, as shown in FIG. 4, the forward exhaust channel edge 154 may be positioned directly below the forwardmost cutting point 115 of the saw blade 114 relative to the worksurface (e.g., relative to a perpendicular line 113 extending from the worksurface 112 and intersecting the forwardmost cutting point 115). In other optional embodiments, as shown in FIG. 3, the forward exhaust channel edge 154 may be positioned forward of the forwardmost cutting point 115 of the saw blade 114 relative to the worksurface 112. In other words, the forward exhaust channel edge 154 may be offset forward of the forwardmost cutting point 115 of the saw blade 114 relative to the worksurface 112 in the forward direction 102 (e.g., offset forward of the perpendicular line 113). This positioning can allow saw dust to fall from the cutting point 115 and downward into the dust exhaust channel 150.

In some embodiments having primary and secondary channel openings 162 and 166 as shown in FIG. 3, both the front channel edge 154a of the primary upper channel opening 162 and the front channel edge 156a of the secondary lower channel opening 166 can be positioned less 45, 50, 55, 60, 65, 70, 75, 80, 85, 90, 105, 100, 105, or 110 degrees from the forwardmost cutting point 115 of the saw blade 114 relative to the axis 116. In other optional embodiments, the rearward channel edge 154b of the primary upper channel opening 162 and the rearward channel edge 156b of the secondary lower channel opening 166 can be positioned less, 70, 75, 80, 85, 90, 105, 100, 105, 110, 115, 120, 125, 130, 135, 140, 145, or 190 degrees from the forwardmost cutting point 115 of the saw blade 114 relative to the axis 116. Thus, both the primary and secondary channel openings 162 and 166 can be positioned generally adjacent the lower front quarter of the saw blade 114.

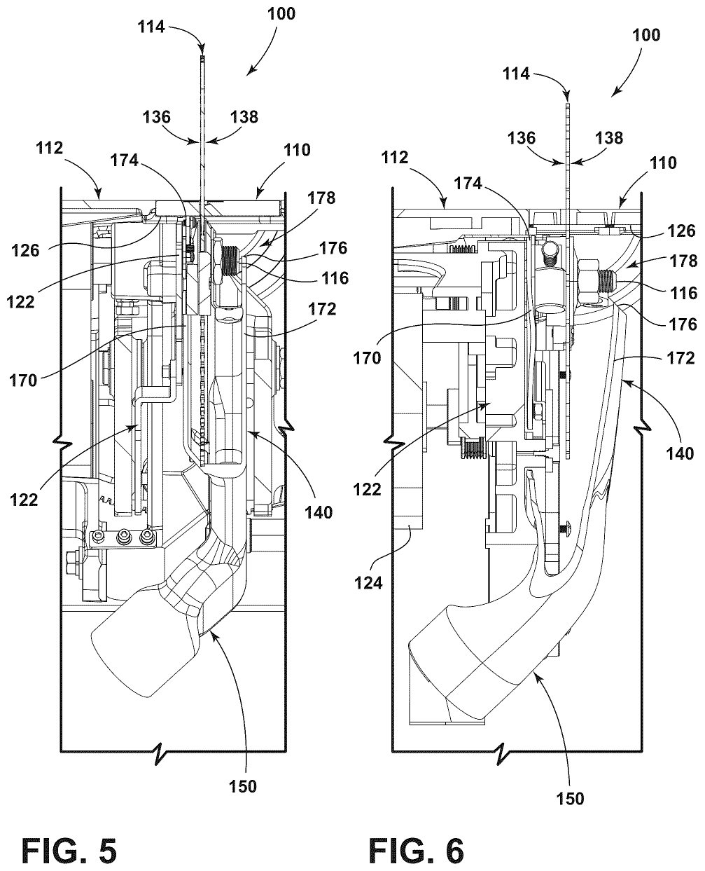

As illustrated in FIGS. 5-6, the saw dust chute 140 may further include a first side surface 170 positioned adjacent to a first side 136 of the saw blade 114 and a second side surface 172 positioned adjacent to a second side 138 of the saw blade 114 opposite the first side 136. The first side surface 170 may include a first side surface upper edge 174. The first side surface upper edge 174 may contact the lower surface 126 of the worksurface 112. In certain optional embodiments, first side surface upper edge 174 may be positioned extremely close to the lower surface 126 of the worksurface 112, for example, within about 5 mm.

The second side surface 172 may include a second side surface upper edge 176. The second side surface upper edge 176 may be positioned lower than the first side surface upper edge 174. For example, the second side surface upper edge 176 may be positioned further from the lower surface 126 of the worksurface 112 than the first side surface upper edge 174 when the saw blade 114 and thus the saw dust chute 140 are in a vertical orientation. As such, a gap 178 may be defined between the second side surface upper edge 176 and the lower surface 126 of the worksurface 112 in such an orientation. The gap 178 may be substantially reduced or eliminated entirely when the saw blade 114 and associated carriage assembly 122 move towards a maximally angled position relative to the worksurface 112 (e.g., a maximal angle away from perpendicular to the worksurface 112). In other words, the second side surface upper edge 176 may contact or be positioned extremely close to the lower surface 126 of the worksurface 112 when the saw blade 114 and associated carriage assembly 122 are maximally angled relative to the worksurface 112. In certain optional embodiments, for example, where the saw blade 114 is fixed perpendicular to the worksurface 112 and may not be angularly adjustable, both the first and second side surface upper edges 174, 176 may be the same height and thus both contact or be positioned extremely close to the lower surface 126 of the worksurface 112. Having both sides of the saw dust chute 140 very near or in contact with the lower surface 126 of the worksurface 112 can help reduce saw dust passing between the lower surface 126 and the saw dust chute 140.

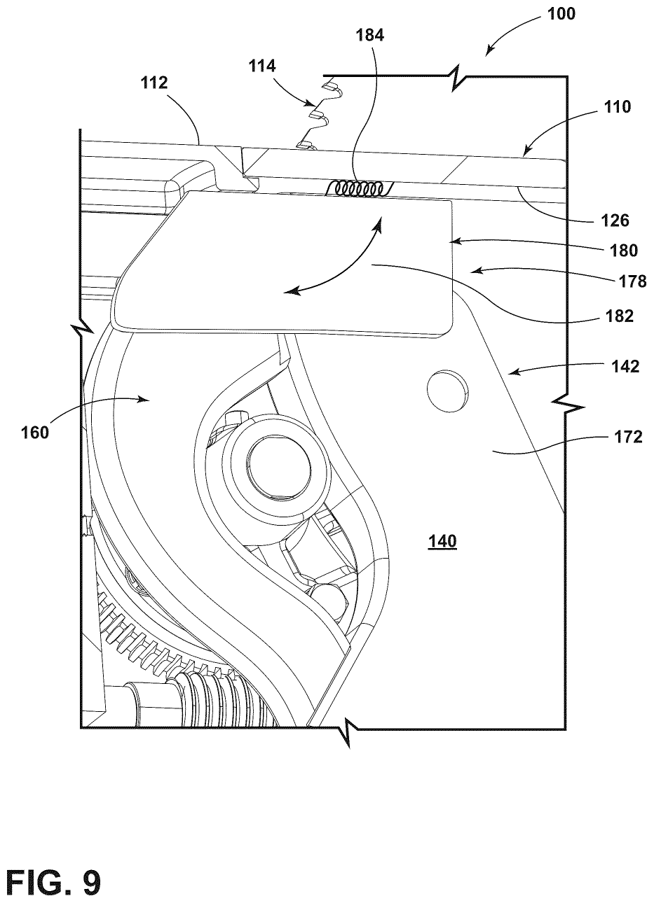

In certain optional embodiments, as illustrated in FIGS. 9-12, the saw dust chute 140 may further include a dust cover assembly 180 configured to cover the gap 178 while not interfering with angling the saw blade 114 and associated carriage assembly 122 relative to the worksurface 112. The dust cover assembly 180 may be shaped to match the contours of the gap 178. The dust cover assembly 180 may be extended at least partially along the second side surface 172 and/or along a forward upper edge 144 of the saw dust chute 140. The dust cover assembly 180 may be configured to cover the gap 178 at any angle of the saw blade 114 and associated carriage assembly 122 relative to the worksurface 112. The dust cover assembly 180 may include a dust cover plate 182 and a spring 184.

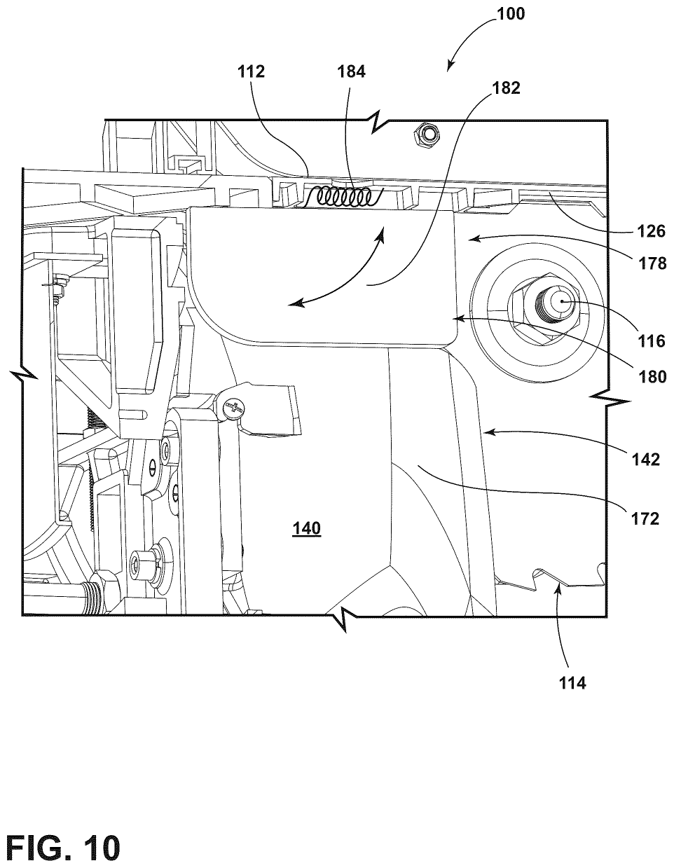

In certain optional embodiments, as illustrated in FIGS. 9-10, the dust cover plate 182 may be pivotally coupled to the lower surface 126 of the worksurface 112 and the spring 184 may be coupled between the dust cover plate 182 and the lower surface 126 of the worksurface 112 opposite the saw dust chute 140. The dust cover plate 182 may be biased towards the second side surface 172 of the saw dust chute 140 using the spring 184. The spring 184 may be a torsion spring in some embodiments. The dust cover plate 182 may be configured to pivot upwards towards the lower surface 126 of the worksurface 112 when the saw blade 114 and associated carriage assembly 122 moved from perpendicular relative to the worksurface 112 to any angle relative to the worksurface 112.

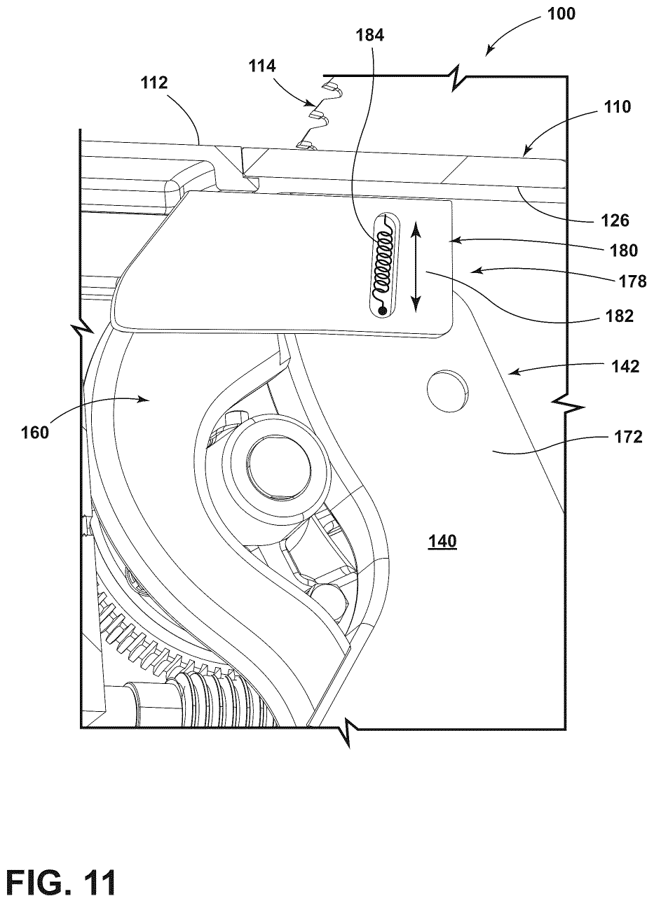

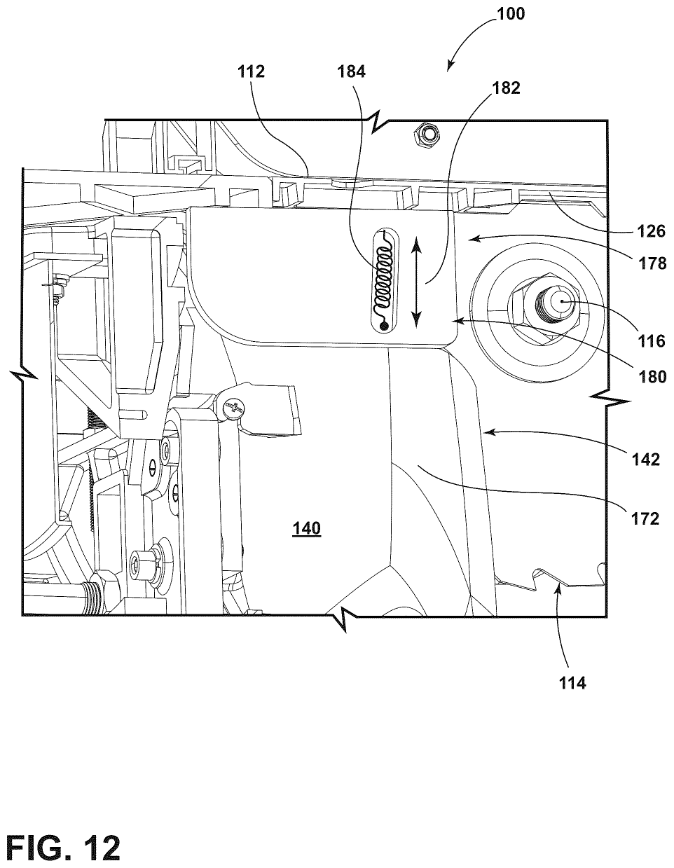

In other optional embodiments, as illustrated in FIGS. 11-12, the dust cover plate 182 may be slidably coupled to the second side surface 172 of the saw dust chute 140. The dust cover plate 182 may be biased towards the lower surface 126 of the worksurface 112 using the spring 184. The spring 184 may be a compression spring. The dust cover plate 182 may be configured to slide downwards along the second side surface 172 of the saw dust chute 140 as the saw blade 114 and associated carriage assembly 122 are moved from perpendicular relative to the worksurface 112 to any angle relative to the worksurface 112.

In other embodiments, the dust cover plate 182 can be pivotally connected to the lower surface 126 and biased towards the second side surface 172 of the saw dust chute 140 via gravity to maintain contact with the second side surface 172 at angle of the saw blade 114 without the use of a spring, though the spring force may provide the added benefit of helping stop the dust cover plate 182 from moving when impacted for instance by saw dust during use of the table saw 110.

In various alternate embodiments, the dust cover assembly 180 may be shaped differently, include multiple cover plates, be coupled between the saw dust chute 140 and the lower surface 126 of the worksurface 112, or generally be configured in various alternate arrangements while still serving the function of covering the gap 178 and not interfering with any angling of the saw blade 114 and associated carriage assembly 122 relative to the worksurface 112. For example, the dust cover assembly 180 may include a flexible membrane, slidable couplings at each of the saw dust chute 140 and the lower surface 126 of the worksurface 112, or some other alternative.

In certain optional embodiments, the outlet of the dust exhaust channel 150 may be coupled to a vacuum such as of a dust collection system. The vacuum may help redirect the sawdust into the main receptacle 142 of the saw dust chute 140 and out of the collection bin 120 of the table saw 110. In other optional embodiments, a hose may be connected between the outlet of the dust exhaust channel 150 and a port defined through a side of the collection bin 120 which may then externally be coupled to the vacuum. In further optional embodiments, the collection bin 120 may include a second port for sucking out any sawdust not captured by the saw dust chute 140 laying on the bottom of the collection bin 120. The use of a vacuum can further enhance the dust collection efficiency of the dust collection chute system by applying a negative pressure within the dust exhaust channel 150 to pull saw dust therein. However, even without the use of an external vacuum, the positioning of the exhaust channel opening 152 adjacent the moving blade 114 during operation and in close proximity to the forwardmost cutting point 115 can help produce a negative pressure within the dust exhaust channel 150 an encourage saw dust into the dust exhaust channel 150.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Although embodiments of the present invention have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A table saw dust deflection system comprising:
a table saw having a worksurface and a saw blade extending partially through the worksurface, the saw blade including an axis; and
a saw dust chute comprising:
a main receptacle shaped to receive a portion of the saw blade, the main receptacle having a forward upper edge; and
a dust exhaust channel having an exhaust channel opening with a forward exhaust channel edge positioned less than 90 degrees from a forwardmost cutting point of the saw blade relative to the axis of the saw blade, the forwardmost cutting point defined at a forward intersection point between the saw blade and the worksurface.

2. The table saw dust deflection system of claim 1, wherein the forward upper edge of the main receptacle is positioned adjacent to a lower surface of the worksurface.

3. The table saw dust deflection system of claim 1, wherein the dust exhaust channel further includes a primary upper channel and a secondary lower channel, and the exhaust channel opening further includes a primary upper channel opening open to the primary upper channel and a secondary lower channel opening open to the secondary lower channel, the primary upper channel opening positioned between the secondary lower channel opening and the forward upper edge, the secondary lower channel opening positioned below the primary upper channel opening, each of the primary upper channel opening and the secondary lower channel opening oriented to feed dust into the dust exhaust channel during operation of the table saw.

4. The table saw dust deflection system of claim 3, wherein a tangent of the saw blade defined at the forwardmost cutting point intersects the primary upper channel opening.

5. The table saw dust deflection system of claim 1, wherein a tangent of the saw blade defined at the forwardmost cutting point intersects the exhaust channel opening.

6. The table saw dust deflection system of claim 1, wherein the exhaust channel opening is positioned directly below the forwardmost cutting point in a direction perpendicular to the worksurface.

7. The table saw dust deflection system of claim 1, wherein the forward exhaust channel edge of the exhaust channel opening is positioned forward of the forwardmost cutting point relative to the worksurface.

8. The table saw dust deflection system of claim 1, wherein:
the main receptacle of the saw dust chute includes a first side surface and a second side surface;
the first side surface is positioned adjacent to a first side of the saw blade, the first side surface including a first side surface upper edge; and
the second side surface of the saw dust chute is positioned adjacent to a second side of the saw blade opposite the first side, the second side surface including a second side surface upper edge positioned lower than the first side surface upper edge.

9. The table saw dust deflection system of claim 8, wherein:
the second side surface upper edge moves towards a lower surface of the worksurface when the saw blade moves to a maximally angled position relative to the worksurface.

10. The table saw dust deflection system of claim 8, further comprising:
a dust cover assembly configured to cover a gap between the second side surface upper edge and a lower surface of the worksurface.

11. The table saw dust deflection system of claim 10, wherein:
the dust cover assembly is configured to maintain coverage of the gap when an angle of the saw blade is changed relative to the worksurface.

12. The table saw dust deflection system of claim 10, wherein:
the dust cover assembly is biased to maintain contact with one or more of the second side surface upper edge or the lower surface of the worksurface.

13. The table saw dust deflection system of claim 1, wherein:
the exhaust channel opening of the dust exhaust channel is positioned further below the worksurface than a lowest point of the saw blade.

14. The table saw dust deflection system of claim 1, wherein:
a rearward exhaust channel edge of the exhaust channel opening is positioned less than 120 degrees from the forwardmost cutting point of the saw blade relative to the axis of the saw blade.

15. A table saw dust deflection system comprising:
a table saw having a worksurface and a saw blade extending partially through the worksurface, the saw blade including an axis; and
a saw dust chute comprising:
a main receptacle shaped to receive a portion of the saw blade, the main receptacle having a forward upper edge; and
a dust exhaust channel having an exhaust channel opening with a rearward exhaust channel edge positioned less than 120 degrees from a forwardmost cutting point of the saw blade relative to the axis of the saw blade, the forwardmost cutting point defined at a forward intersection point between the saw blade and the worksurface.

16. The table saw dust deflection system of claim 15, wherein the dust exhaust channel further includes a primary upper channel and a secondary lower channel, and the exhaust channel opening further includes a primary upper channel opening open to the primary upper channel and a secondary lower channel opening open to the secondary lower channel, the primary upper channel opening positioned between the secondary lower channel opening and the forward upper, the secondary lower channel opening positioned between the primary upper channel opening and the rearward exhaust channel edge, each of the primary upper channel opening and the secondary lower channel opening oriented to feed dust into the dust exhaust channel during operation of the table saw.

17. The table saw dust deflection system of claim 16, wherein a tangent of the saw blade defined at the forwardmost cutting point intersects the primary upper channel opening.

18. The table saw dust deflection system of claim 15, wherein:
the main receptacle of the saw dust chute includes a first side surface and a second side surface;
the first side surface is positioned adjacent to a first side of the saw blade, the first side surface including a first side surface upper edge; and
the second side surface of the saw dust chute is positioned adjacent to a second side of the saw blade opposite the first side, the second side surface including a second side surface upper edge positioned lower than the first side surface upper edge.

19. The table saw dust deflection system of claim 18, wherein:
the second side surface upper edge moves towards a lower surface of the worksurface when the saw blade moves to a maximally angled position relative to the worksurface.

20. The table saw dust deflection system of claim 18, further comprising:
a dust cover assembly configured to cover a gap between the second side surface upper edge and a lower surface of the worksurface.
